(19) United States
(12) Patent Application Publication
(10) Pub. No.: US 2026/0273962 A1
(43) Pub. Date: Sep. 17, 2026

(54) PRINTING DEVICE

(71) Applicant: SEIKO EPSON CORPORATION, TOKYO (JP)

(72) Inventors: Norihiro MASUDA, SHIOJIRI-SHI (JP); Yuki ONO, MATSUMOTO-SHI (JP)

(21) Appl. No.: 19/565,880

(22) Filed: Mar. 13, 2026

(30) Foreign Application Priority Data
Mar. 13, 2025 (JP) 2025-040057

(51) Int. Cl. B41J 11/00; B41J 25/00

(52) U.S. Cl. CPC B41J 11/00218; B41J 11/00214; B41J 11/007; B41J 2025/008

(57) ABSTRACT

A printing device includes a head; an irradiation device; and a medium support section, wherein the irradiation device has an ultraviolet irradiation section, a cover member, and a cover member support section that supports the cover member and that has a light shielding property, the cover member support section has a first portion extending in the second direction and a second portion extending in the third direction, a first end section of the second portion has a first bent section bent toward the medium support section side, a first tip end section is arranged within 0.3 mm from the end section on the side closer to the irradiation section, in the third direction toward the first portion, and the distance from the medium support section is greater than or equal to the distance from the medium support section to a nozzle surface, and is less than or equal to 50% of the distance from the medium support section to the cover member.

The present application is based on, and claims priority from JP Application Serial Number 2025-040057, filed Mar. 13, 2025, the disclosure of which is hereby incorporated by reference herein in its entirety.

### BACKGROUND

### 1. Technical Field

The present disclosure relates to a printing device.

### 2. Related Art

In the related art, various printing devices have been used. Among these, for example, as disclosed in JP-A-2007-203624 and JP-A-2004-167980, there is a printing device including a head that ejects ultraviolet curable ink from nozzles provided on a nozzle surface, and an irradiation section that irradiates the ultraviolet curable ink that landed on a print medium with ultraviolet rays. In the printing device having such a configuration, it is possible to suitably suppress bleeding, color mixing, and the like of an image formed on a print medium.

In a related art printing device including a head that ejects ultraviolet curable ink and an irradiation section that irradiates the ultraviolet curable ink with ultraviolet rays, it is required to suppress ultraviolet irradiation leakage so that the ultraviolet rays irradiating the ultraviolet curable ink do not reach the head. Therefore, for example, JP-A-2007-203624 discloses a technique of arranging a light shielding plate between an ultraviolet ray irradiation device and a recording head in order to suppress the ultraviolet irradiation leakage. JP-A-2004-167980 discloses a technique of arranging a light trap between an ultraviolet ray irradiation section and a recording head in order to suppress the ultraviolet irradiation leakage. However, in the related art printing devices including a head that ejects ultraviolet curable ink and an irradiation section that irradiates the ultraviolet curable ink with ultraviolet rays, there are cases where it is not possible to sufficiently suppress the ultraviolet irradiation leakage with which the ultraviolet curable ink is irradiated.

### SUMMARY

The printing device of the present disclosure, which solves the above problem, includes a head having a nozzle surface in which are formed nozzles configured to eject ultraviolet curable ink; an irradiation device that irradiates, with ultraviolet rays, the ultraviolet curable ink that was ejected from the nozzles and that landed on a print medium; a movement section configured to move the print medium and the irradiation device relative to each other in a relative movement direction; and a medium support section that supports the print medium at a position facing the head and the irradiation device, wherein the irradiation device has an ultraviolet irradiation section configured to irradiate the ultraviolet rays, an irradiation range of the ultraviolet rays extending in a first direction intersecting the relative movement direction, a cover member that is arranged between the medium support section and the irradiation section and that has translucency, and a cover member support section that supports one end section and an other end section of the cover member in the relative movement direction and that has a light shielding property, the cover member support section has a first portion extending in a second direction in which the cover member and the medium support section face each other and a second portion that extends from an end section of the first portion on the medium support section side in a third direction, which intersects the first direction and the second direction, a first end section of the second portion, which is an end section on the irradiation section side in the third direction, has a first bent section bent toward the medium support section side, the first bent section is arranged to span from the one end section of the irradiation section to the other end section in the first direction, a first tip end section, which is a tip end of the first bent section, is arranged within a distance of 0.3 mm from an end section on a side closer to the irradiation section toward the first portion in the third direction, and a distance from the medium support section in the second direction is equal to or greater than a distance from the medium support section to the nozzle surface in the second direction, equal to or less than 50% of a distance from the medium support section to the cover member in the second direction.

### BRIEF DESCRIPTION OF THE DRAWINGS

FIG. 1 is a side sectional view of a printing device according to a first embodiment of the present disclosure.

FIG. 2 is a partially enlarged view of the printing device of FIG. 1.

FIG. 3 is a schematic view of the printing device of FIG. 1.

FIG. 4 is a schematic view of the periphery of an irradiation device of the printing device in FIG. 1.

FIG. 5 is a bottom view of an irradiation device of the printing device of FIG. 1.

FIG. 6 is a partially enlarged view of a printing device according to a second embodiment of the present disclosure.

FIG. 7 is a schematic view of the printing device of FIG. 6.

FIG. 8 is a schematic view of the periphery of an irradiation device of the printing device of FIG. 6.

FIG. 9 is a schematic view of a printing device according to a third embodiment of the present disclosure.

FIG. 10 is a schematic view of the periphery of an irradiation device of the printing device of FIG. 9.

FIG. 11 is a schematic view of a printing device according to a fourth embodiment of the present disclosure.

FIG. 12 is a schematic view of the periphery of an irradiation device of the printing device of FIG. 11.

FIG. 13 is a schematic view of a printing device of the first reference example.

FIG. 14 is a schematic view of the periphery of an irradiation device of a printing device of the second reference example.

### DESCRIPTION OF EMBODIMENTS

First, a brief overview of the present disclosure is described.

A printing device according to a first aspect of the present disclosure for solving the above problem, includes a head having a nozzle surface in which are formed nozzles configured to eject ultraviolet curable ink; an irradiation device that irradiates, with ultraviolet rays, the ultraviolet curable ink that was ejected from the nozzles and that landed on a print medium; a movement section configured to move the print medium and the irradiation device relative to each other in a relative movement direction; and a medium support section that supports the print medium at a position facing the head and the irradiation device, wherein the irradiation device has an ultraviolet irradiation section configured to irradiate the ultraviolet rays, an irradiation range of the ultraviolet rays extending in a first direction intersecting the relative movement direction, a cover member that is arranged between the medium support section and the irradiation section and that has translucency, and a cover member support section that supports one end section and an other end section of the cover member in the relative movement direction and that has a light shielding property, the cover member support section has a first portion extending in a second direction in which the cover member and the medium support section face each other and a second portion that extends from an end section of the first portion on the medium support section side in a third direction, which intersects the first direction and the second direction, a first end section of the second portion, which is an end section on the irradiation section side in the third direction, has a first bent section bent toward the medium support section side, the first bent section is arranged to span from the one end section of the irradiation section to the other end section in the first direction, a first tip end section, which is a tip end of the first bent section, is arranged within a distance of 0.3 mm from an end section on a side closer to the irradiation section toward the first portion in the third direction, and a distance from the medium support section in the second direction is equal to or greater than a distance from the medium support section to the nozzle surface in the second direction, equal to or less than 50% of a distance from the medium support section to the cover member in the second direction.

According to the present aspect, the irradiation device includes a cover member support section, the cover member support section includes the first bent section that is arranged along the first direction and that bends toward the medium support section side, a first tip end section of the first bent section is arranged within a distance of 0.3 mm from an end section of the irradiation section, and a distance from the medium support section is equal to or greater than a distance from the medium support section to the nozzle surface, equal to or less than 50% of a distance from the medium support section to the cover member. With such a configuration, the cover member support section can suppress the ultraviolet irradiation leakage with which the ultraviolet curable ink is irradiated.

The printing device according to a second aspect of the present disclosure is the aspect according to the first aspect, further includes a light trap member that is arranged below the second portion and that extends in the second direction, wherein the light trap member is arranged to span from the one end section of the irradiation section to the other end section in the first direction and an inclination angle with respect to the second portion is 20 degrees or more, and 50 degrees or less.

According to this aspect, the light trap member is arranged below the second portion, the light trap member is arranged along the second direction, and the inclination angle of the light trap member with respect to the second portion is 20 degrees or more and 50 degrees or less. With this configuration, the light trap member in addition to the cover member support section can suitably suppress the ultraviolet irradiation leakage to be irradiated to the ultraviolet curable ink.

The printing device according to a third aspect of the present disclosure is the aspect according to the second aspect, wherein the distance between a second tip end section of the light trap member, which is the tip end on the medium support section side, and the medium support section, is greater than or equal to the distance from the medium support section to the nozzle surface, and less than or equal to 1.8 mm.

According to present aspect, the distance between the second tip end section of the light trap member and the medium support section is equal to or greater than the distance from the medium support section to the nozzle surface and equal to or less than 1.8 mm. With this configuration, the light trap member can particularly preferably suppress the ultraviolet irradiation leakage with which the ultraviolet curable ink is irradiated.

The printing device according to a fourth aspect of the present disclosure is the aspect according to the third aspect, wherein the light trap member includes a third portion extending in the second direction to outside the first portion and a fourth portion extending in the third direction from the end section on the medium support section side of the third portion in the second direction, a second end section, which is the end section on the irradiation section side in the third direction of the fourth portion, has a second bent section that bends toward the medium support section side, and the second tip end section is a tip end of the second bent section.

According to the present aspect, the light trap member includes the third portion extending in the second direction outside the first portion, and in the second direction, the fourth portion extending in the third direction from the end section of the third portion on the medium support section side. The second end section has a second bent section, and the second tip end section is a tip section of the second bent section. With this configuration, it is possible to easily configure the light trap member capable of suitably suppressing the ultraviolet irradiation leakage irradiated to the ultraviolet curable ink.

The printing device according to a fifth aspect of the present disclosure is the aspect according to any one of the second to fourth aspects, wherein the light trap member also serves as a wiring protection section that protects wiring of the irradiation device.

According to this aspect, the light trap member also serves as a wiring protection section that protects the wiring of the irradiation device. With this configuration, the size and structure can be reduced and simplified as compared with a configuration in which the light trap member and the wiring protection section are separately provided.

### FIRST EMBODIMENT

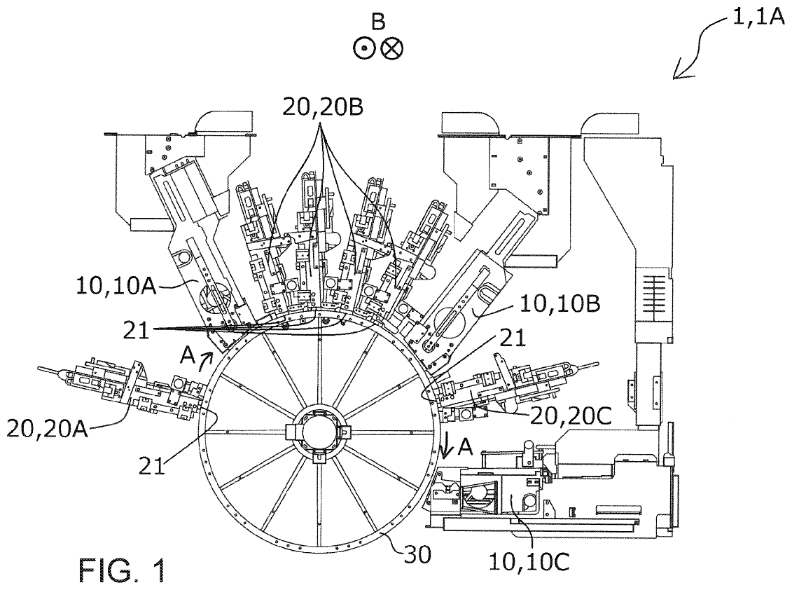

Embodiments of the present disclosure will be specifically described below with reference to the drawings. First, an outline of a printing device 1A according to a first embodiment as an example of a printing device 1 of the disclosure will be described with reference to FIGS. 1 to 3. The printing device 1A of the present embodiment is a printing device that forms an image by ejecting ultraviolet curable ink onto a print medium and that fixes the ultraviolet curable ink on the print medium by irradiating the ultraviolet curable ink that has landed on the print medium with ultraviolet rays.

As illustrated in FIGS. 1 to 3, the printing device 1A, in the present embodiment, includes a plurality of heads 20 each having a nozzle surface 21 in which a plurality of nozzles for ejecting ultraviolet curable ink are formed. The printing device 1A includes a plurality of irradiation devices 10 for irradiating the ultraviolet rays onto the ultraviolet curable ink that is ejected from the nozzles and landed on the print medium. In addition, it includes a drum 30 that supports the print medium and that is configured to rotate so as to transport the print medium in a transport direction A. A head 20 of the present embodiment is a so-called line head in which a plurality of nozzles that ejects ultraviolet curable ink are arranged in a first direction B, which corresponds to a width direction which intersects the transport direction A, but may be a so-called serial type head mounted on a carriage that reciprocates in the first direction B. In this case, an irradiation device 10 is mounted on an end section of the carriage in the one direction B.

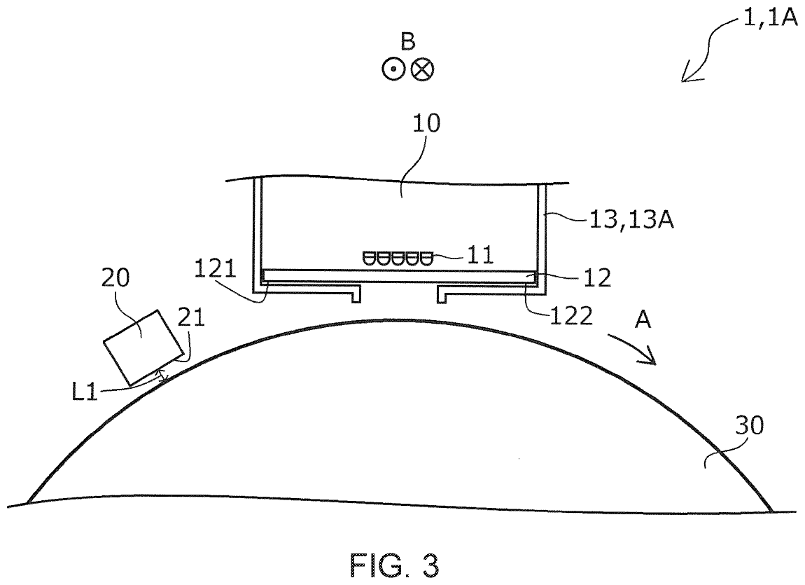

As illustrated in FIGS. 1 and 3, each irradiation device 10 is arranged downstream of the corresponding head 20 along the transport direction A. In other words, the irradiation device 10 irradiates the ultraviolet rays when the ultraviolet curable ink is discharged from the corresponding head 20. More specifically, an irradiation device 10A amongst the irradiation devices 10 illustrated in FIG. 1 corresponds to a head 20A, which is capable of ejecting white ink, an irradiation device 10B amongst the irradiation devices 10 illustrated in FIG. 1 corresponds to a head 20B capable of ejecting black, cyan, magenta, and yellow ink, and an irradiation device 10C amongst the irradiation devices 10 illustrated in FIG. 1 corresponds to a head 20C capable of ejecting clear ink.

The drum 30 serves as a movement section that moves the print medium relative to the irradiation device 10 in a relative movement direction, and also serves as a medium support section that supports the print medium at a position opposite the head 20 and the irradiation device 10. However, the configuration of the movement section or the medium support section is not particularly limited, and the configuration of the head 20 is not particularly limited as long as the head 20 has the nozzle surface 21 in which a plurality of nozzles for ejecting the ultraviolet curable ink are formed.

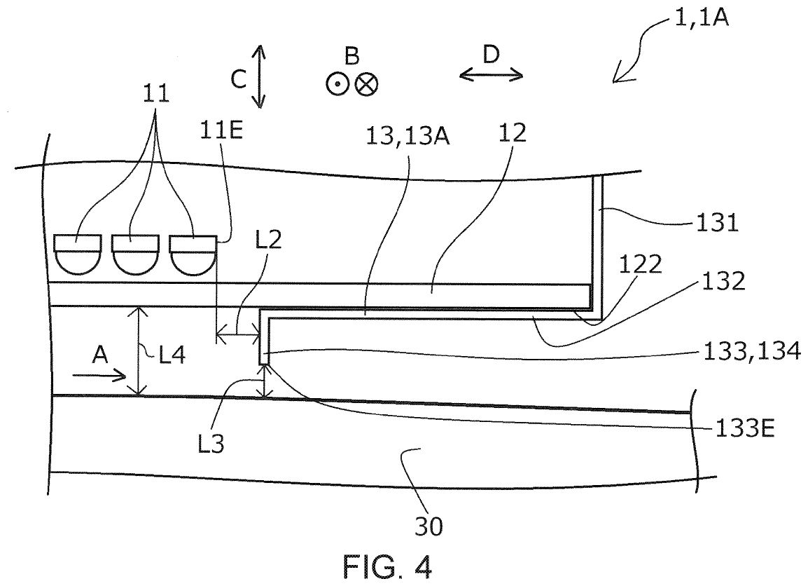

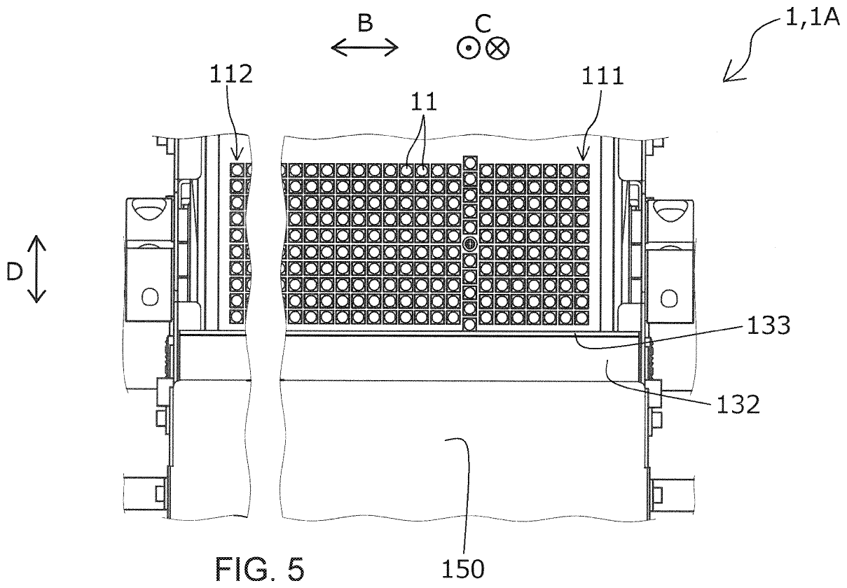

Next, the details of the irradiation device 10, which is a main section of the printing device 1A of the present embodiment, will be described with reference to FIGS. 4 and 5 in addition to FIGS. 1 to 3. As illustrated in FIG. 4 and the like, the irradiation device 10 of the present embodiment includes an irradiation section 11 that irradiates ultraviolet rays, a cover member 12, and a cover member support section 13. As illustrated in FIG. 5, the irradiation section 11 extends in a first direction B corresponding to a width direction intersecting a transport direction A, which is a relative movement direction of the print medium and the irradiation device 10. In other words, the irradiation section 11 has an irradiation range of ultraviolet rays extending in the first direction B.

In the present embodiment, as illustrated in FIG. 5, the irradiation section 11 includes a plurality of light emitting diodes arranged in the first direction B and the third direction D. However, the disclosure is not limited to such a configuration, and the irradiation section 11 may be constituted by a single light-emitting element that extends in the first direction B. The cover member 12 is formed of a material having translucency, and is arranged between the surface of the drum 30 as a medium support section and the irradiation section 11. A cover member support section 13A of the present embodiment, which serves as the cover member support section 13, has light-shielding properties and supports one end section 121 on one side and the other end section 122 of the cover member 12 in the transport direction A.

As shown in FIG. 4, the cover member support section 13A includes a first portion 131 that extends in the second direction C, which is the direction in which the cover member 12 and the drum 30 face each other, and a second portion 132 that extends in the third direction D, which intersects with both the first direction B and the second direction C, from a drum 30 side end section of the first portion 131. Here, a first end section 134, which is an end section of the second portion 132 on the irradiation section 11 side in the third direction D, has a first bent section 133 bent toward the drum 30 side (the lower side).

As illustrated in FIG. 5, the first bent section 133 is arranged along the width direction (first direction B) so as to extend from one end section 111 of the irradiation section 11 to the other end section 112. A first tip end section 133E, which is the tip end of the first bent section 133, is arranged so that the distance L2 in the third direction D to an end section 11E side (the right side in FIG. 4) of the irradiation section 11 is a distance within 0.3 mm toward the first portion 131 side. In addition, the first tip end section 133E is configured so that the distance L3 from the drum 30 in the second direction C is greater than or equal to the distance L1 from the drum 30 to the nozzle surface 21 in the second direction C and is not greater than 50% of the distance L4 from the drum 30 to the cover member 12 in the second direction C.

As described above, in the printing device 1A of the example, the irradiation device 10 includes the cover member support section 13A, and the cover member support section 13A includes the first bent section 133, which is arranged over the first direction B and which is bent toward the drum 30 side. The first tip end section 133E of the first bent section 133 is arranged within a range of 0.3 mm from the end section 11E of the irradiation section 11, and the distance L3 from the drum 30 is equal to or greater than the distance L1 from the drum 30 to the nozzle surface 21 and is equal to or less than 50% of the distance L4 from the drum 30 to the cover member 12.

With such a configuration, the printing device 1A of the present embodiment can suppress the ultraviolet irradiation leakage radiated to the ultraviolet curable ink by the cover member support section 13A. In other words, the printing device 1A of the present embodiment can reduce ultraviolet irradiation leakage to the maximum extent with a simple mechanism without having a complicated mechanism. By reducing the ultraviolet irradiation leakage, the curing of the ink in the head 20 is suppressed, and it is expected that the deterioration of the image quality due to the nozzle clogging and trajectory bending of the ink is reduced, the number of times of the periodic cleaning is reduced, the waste liquid is reduced, and the productivity is improved.

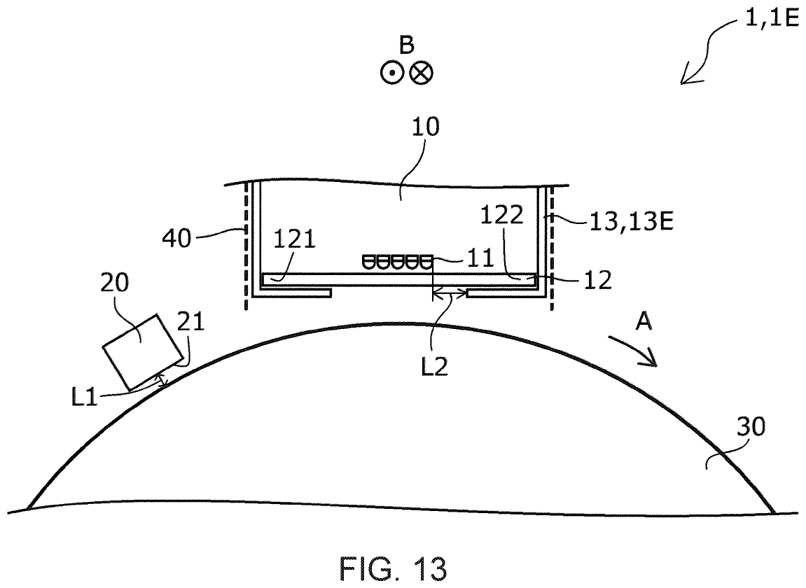

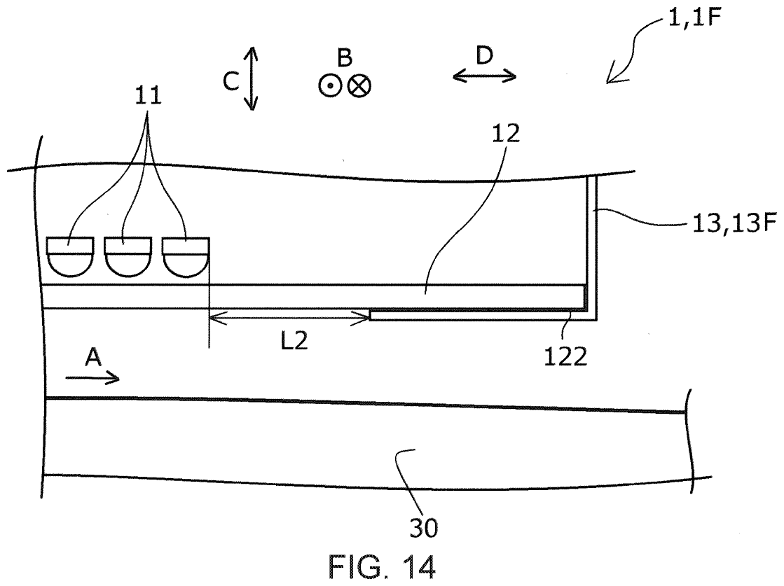

Here, the fact that the printing device 1A of the present embodiment can suppress the ultraviolet irradiation leakage irradiated to the ultraviolet curable ink will be further described in comparison with a printing device 1E of a first reference example illustrated in FIG. 13 and a printing device 1F of a second reference example illustrated in FIG. 14. As illustrated in FIGS. 13 and 14, the printing device 1E of first reference example and the printing device 1F of the second reference example have a configuration in which the cover member support section 13 (cover member support section 13E, cover member support section 13F) does not have the first bent section 133. The following data on the ultraviolet irradiation leakage is based on a simulation using LightTools, which is simulation software by Synopsys, Inc.

In the printing device 1F of the second reference example, when the end section 11E from the cover member support section 13F to the distance L2 on the side closer to the irradiation section 11 is changed from 5 mm to 0.3 mm, the value of the ultraviolet irradiation leakage is reduced from 2.9×10⁻⁴ to 4.6×10⁻⁵. Therefore, it was found that the distance L2 from the cover member support section 13F to the end section 11E on the side close to the irradiation section 11 is preferably within 0.3 mm. Although the shorter the distance L2 is, the more the ultraviolet irradiation leakage can be suppressed, if the distance L2 is too short, there is a risk that a sufficient irradiation amount for curing the ultraviolet curable ink cannot be obtained.

Even when a light shielding member 40 having various configurations, such as a light shielding plate disclosed in the related art, is provided in the irradiation device 10, the effect of suppressing the ultraviolet irradiation leakage is still insufficient. For example, in the printing device 1E of the first reference example, as indicated by the dashed line in FIG. 13, a light shielding plate is provided as the light shielding member 40 having a configuration that is to the outside of the cover member support section 13E of the irradiation device 10 and that does not face the cover member 12. In this case, when the distance L2 from the cover member support section 13E to the end section 11E on the side closer to the irradiation section 11 is set to 5.9 mm, and the distance from the tip end of the light shielding plate on the drum 30 side in the second direction C to the drum 30 is set to 1.8 mm, the value of the ultraviolet irradiation leakage is approximately 3×10⁻⁴. Even when other configurations of the light shielding member 40, such as a light trap, are provided, the value of the ultraviolet irradiation leakage was also approximately 3×10⁻⁴. This is a value that is not significantly different from the ultraviolet irradiation leakage value of 2.9×10⁻⁴ obtained in the printing device 1F of the second reference example, in which no light shielding member 40 such as a light shielding plate is provided, when the distance L2 from the cover member support section 13E to the end section 11E on the side closer to the irradiation section 11 is set to 5 mm.

Next, in the printing device 1A of the present embodiment, the ultraviolet irradiation leakage value was measured when the distance L2 was set to 0.3 mm and the distance L3 from the first tip end section 133E to the drum 30 in the second direction C was set to 3.4 mm, 2.4 mm, and 1.4 mm. Then, the result was 4.6×10⁻⁵ when the distance L3 was 3.4 mm, 2.1×10⁻⁵ when the distance L3 was 2.4 mm, and 1.5×10⁻⁶ when the distance L3 was 1.4 mm.

Note that in both the printing device 1F of the second reference example, where the distance L2 is 0.3 mm, and the printing device 1A of the present embodiment, the distance between the lower surface at the position of the end section on the irradiation section 11 side of the part corresponding to the second portion 132 of the cover member support section 13 and the drum 30 is 4.88 mm. Therefore, in the above description, the lengths of the first bent section 133 in the second direction C are 1.48 mm, 2.48 mm, and 3.48 mm in this order. Since the ultraviolet irradiation leakage value in the printing device 1F of the second reference example, where the distance L2 is 0.3 mm (a configuration without the first bent section 133), is 4.6×10⁻⁵, the ultraviolet irradiation leakage value of 4.6×10⁻⁵ when the distance L3 is 3.4 mm is not different from the value obtained in the printing device 1F of the second reference example where the distance L2 is 0.3 mm. In contrast, the ultraviolet irradiation leakage value of 2.1×10⁻⁵ when the distance L3 is 2.4 mm is approximately half of the value obtained in the printing device 1F of the second reference example where the distance L2 is 0.3 mm, and the ultraviolet irradiation leakage value of 1.5×10⁻⁶ when the distance L3 is 1.4 mm is more than one order of magnitude lower than the irradiation leakage value in the printing device 1F of the second reference example where the distance L2 is 0.3 mm. From this result, the distance L3 is preferably 2.4 mm or less. Since the distance between the lower surface at the position of the end section on the irradiation section 11 side of the part corresponding to the second portion 132 of the cover member support section 13 and the drum 30 is 4.88 mm, in other words, it is preferable that the distance L3 be 50% or less of the distance between the lower surface of the part corresponding to the second portion 132 of the cover member support section 13 and the drum 30.

### SECOND EMBODIMENT

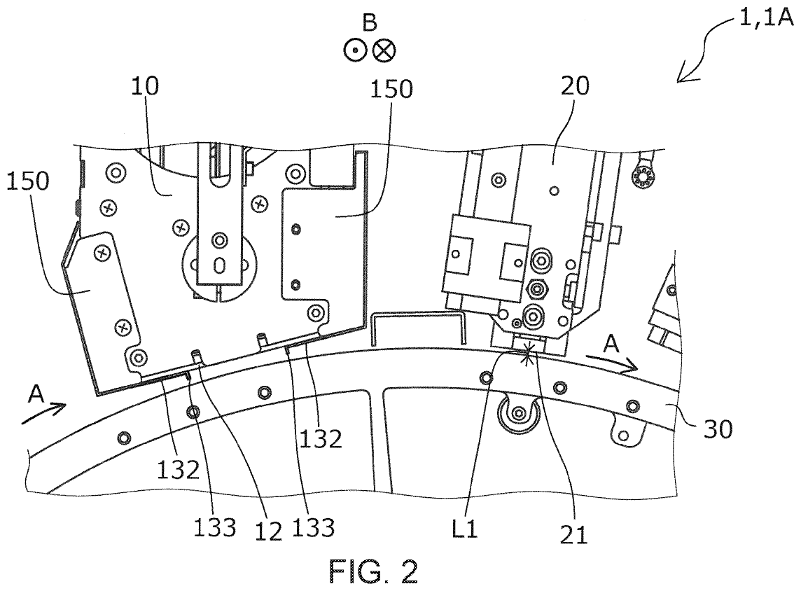

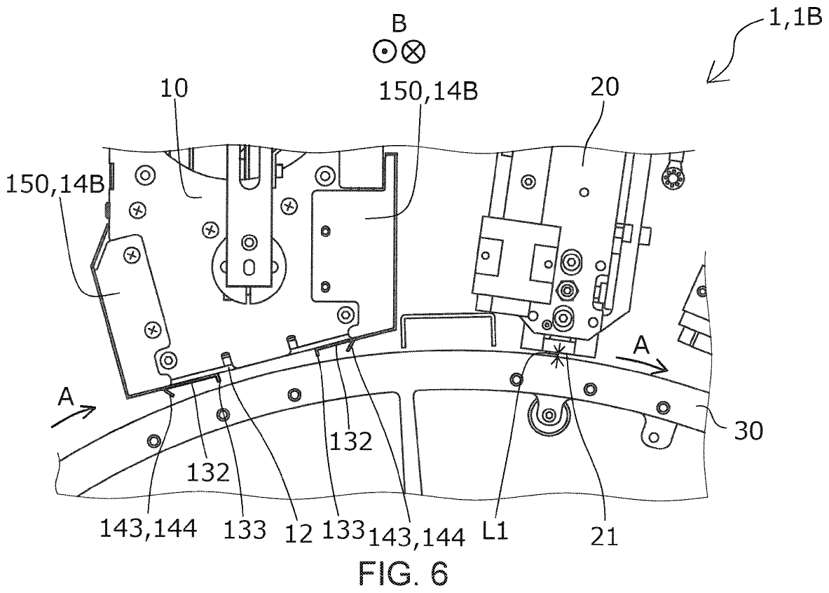

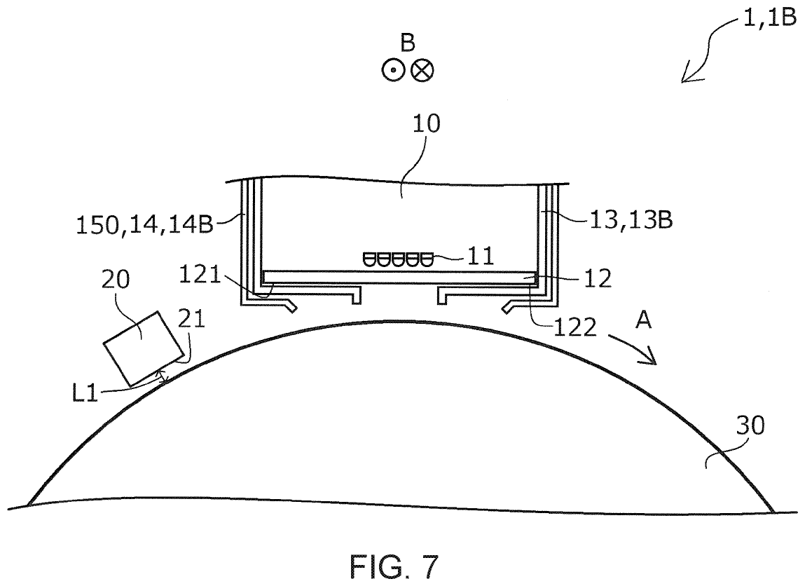

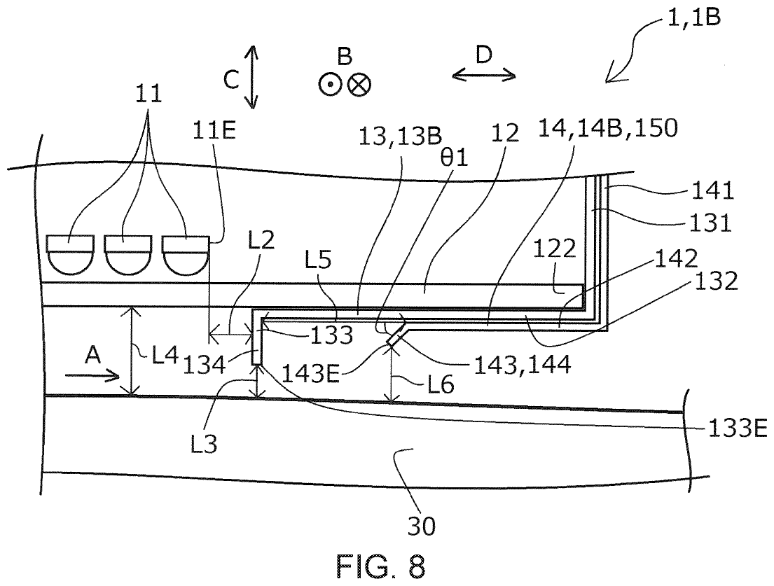

Next, a printing device 1B according to a second embodiment will be described with reference to FIGS. 6 to 8. FIG. 6 is a view corresponding to FIG. 2 in the printing device 1A of the first embodiment, FIG. 7 is a diagram corresponding to FIG. 3 in the printing device 1A of the first embodiment, and FIG. 8 is a diagram corresponding to FIG. 4 in the printing device 1A of the first embodiment. In FIGS. 6 to 8, the same reference numerals are given to the common constituent member as those in the first embodiment, and the detailed description thereof will be omitted. Here, the printing device 1B of the present embodiment has the same configuration as the printing device 1A of the first embodiment except for the configuration of the irradiation device 10. For this reason, the printing device 1B of the present embodiment has the same features as those of the printing device 1A of the first embodiment, except for the parts described below.

As illustrated in FIGS. 6 to 8, in the printing device 1B of the example, a wiring protection section 150 having a configuration different from that of the wiring protection section 150 of the printing device 1A of first embodiment is provided on the outside of the cover member support section 13 (cover member support section 13B) with respect to the irradiation device 10 having the same configuration as that of the irradiation device 10 of the printing device 1A of the first embodiment. The wiring protection section 150 of the present embodiment also serves as a light shielding member 14 (light shielding member 14B). As shown in FIGS. 6 to 8, a light trap member 143 is provided on the light shielding member 14B (wiring protection section 150).

Here, in the printing device 1B of the present embodiment, as illustrated in FIG. 8, the light trap member 143 includes a third portion 141 extending in the second direction C on the outside of the first portion 131, and a fourth portion 142 extending in the third direction D from an end section of the third portion 141 on the drum 30 side (lower side) in the second direction C. A second end section 144, which is located on the irradiation section 11 side of the fourth portion 142 in the third direction D, includes a second bent section (light trap member 143) that is bent toward the drum 30, and a second tip end section 143E is the end section of the second bent section. With such a configuration, it is possible to easily configure the light trap member 143 capable of suitably suppressing the ultraviolet irradiation leakage irradiated to the ultraviolet curable ink.

In other words, the printing device 1B of the present embodiment includes the light trap member 143 that is located below the second portion 132 and that extends in the second direction C. The light trap member 143 is arranged at the position from the one end section 111 on one side of the irradiation section 11 to the other end section 112 on the other side in the first direction B, and the inclination angle θ1 with respect to the second portion 132 is 50 degrees.

The printing device 1B of the present embodiment is configured as described above, and thus, it is possible to suitably suppress the ultraviolet irradiation leakage radiated to the ultraviolet curable ink by the light trap member 143 in addition to the cover member support section 13B. Note that although it is common to the printing device 1A of the first embodiment, also in the printing device 1B of the present embodiment, the inclination angle of the first bent section 133 with respect to the second portion 132 is 90°.

Here, the fact that the printing device 1B of the present embodiment can suppress the ultraviolet irradiation leakage irradiated to the ultraviolet curable ink will be further described below. Specifically, in the printing device 1B of the present embodiment, a preferable distance of the distance L5 in the third direction D from the first bent section 133 to the light trap member 143 as the second bent section illustrated in FIG. 8 will be described.

In this example, the distance L5 is the distance from the bending start position of the first bent section 133 to the bending start position of the light trap member 143. The distance between the drum 30 and the second tip end section 143E of the light trap member 143, which is located at the drum 30 side end, is defined as the distance L6.

After setting the distance L3 to 1.4 mm and then setting the distance L5 to 20.0 mm, 15.0 mm, and 10.0 mm, the ultraviolet irradiation leakage value was measured, and in all cases, the value was 4.9×10⁻⁷. When the distance L5 is 20.0 mm, the distance L6 is 1.8 mm; when the distance L5 is 15.0 mm, the distance L6 is 1.2 mm; and when the distance L5 is 10.0 mm, the distance L6 is 0.7 mm. This indicates that the ultraviolet irradiation leakage irradiated to the ultraviolet curable ink can be suppressed more suitably than 1.5×10⁻⁶ in the printing device 1A of the first embodiment when the distance L3 is set to 1.4 mm. It was also found that the position of the distance L5 does not greatly affect the ultraviolet irradiation leakage.

### THIRD EMBODIMENT

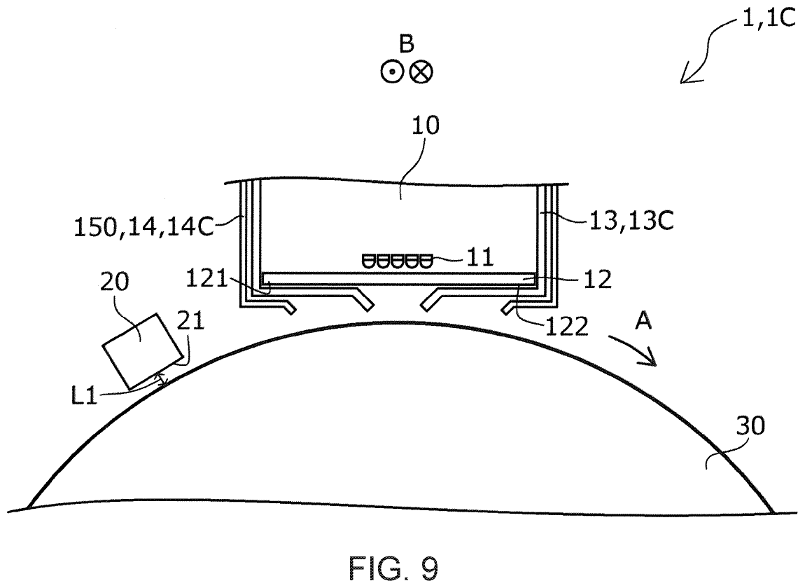

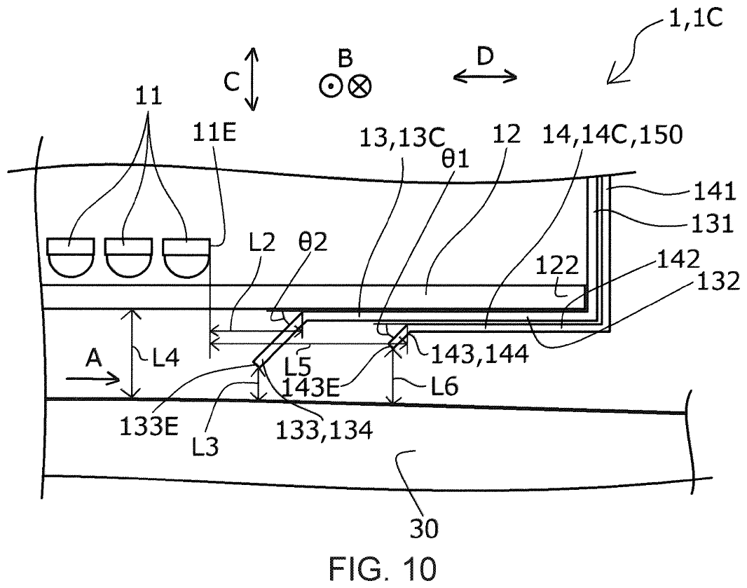

Next, a printing device 1C of a third embodiment will be described with reference to FIGS. 9 and 10. FIG. 9 is a view corresponding to FIG. 3 in the printing device 1A of the first embodiment, and FIG. 10 is a view corresponding to FIG. 4 in the printing device 1A of the first embodiment. In FIGS. 9 and 10, constituent members that are common to those in the above first and second embodiments are indicated by the same reference symbols, and detailed explanations are omitted. Here, the printing device 1C of the present embodiment has the same configuration as the printing device 1 of the first embodiment and the second embodiment except for the configuration of the irradiation device 10. For this reason, the printing device 1C of the present embodiment has the same features as those of the printing device 1 of the first embodiment and the second embodiment, except for the parts described below.

As shown in FIGS. 9 and 10, the printing device 1C of the present embodiment differs from the printing device 1B of the second embodiment in the following points. Regarding the cover member support section 13, the first tip end section 133E, which is the tip end of the first bent section 133, is positioned such that the distance L2 in the third direction D to the end section 11E on the side closer to the irradiation section 11 (the right side in FIG. 10) is 5.9 mm, the distance L3 in the second direction C from the drum 30 is 1.0 mm, and the inclination angle θ2 of the first bent section 133 relative to the second portion 132 is 45°. In addition, regarding the light shielding member 14, the printing device 1C differs from the light shielding member 14 (light shielding member 14B) of the printing device 1B of the second embodiment in that the distance L5 is 19.4 mm and the distance L6 is 1.8 mm.

The ultraviolet irradiation leakage value in the printing device 1C of the present embodiment was 2.5×10⁻⁶, and when the printing device 1C was configured such that the only difference was setting the inclination angle θ2 of the first bent section 133 relative to the second portion 132 to 90°, the ultraviolet irradiation leakage value was 2.4×10⁻⁶. In other words, even when only the inclination angle θ2 was changed from 45° to 90°, the effect of suppressing the ultraviolet irradiation leakage was substantially the same.

### FOURTH EMBODIMENT

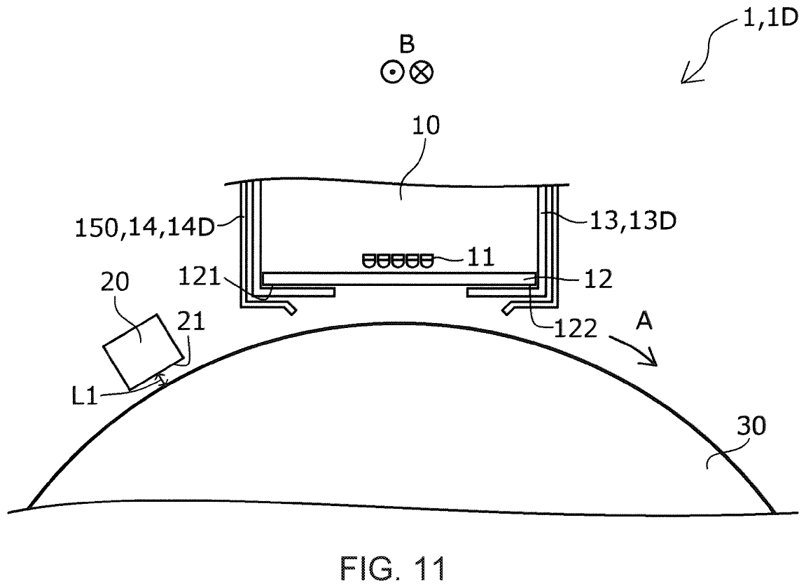

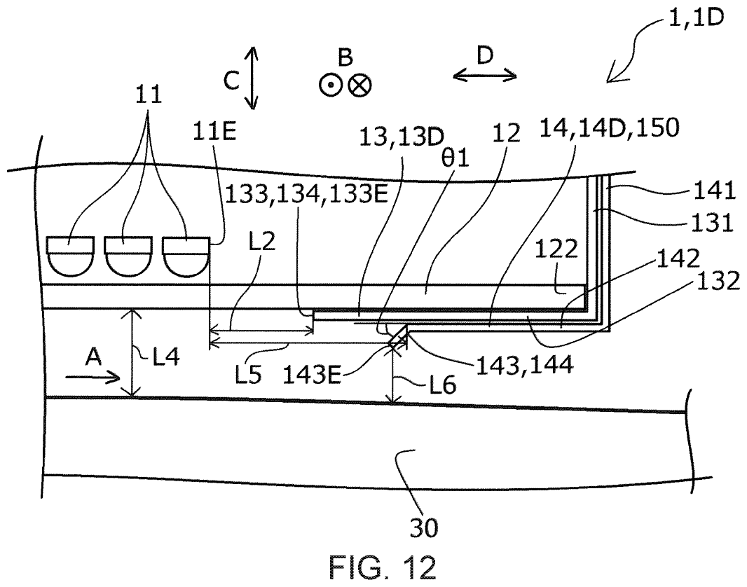

Next, a printing device 1D of a fourth embodiment will be described with reference to FIGS. 11 and 12. FIG. 11 is a view corresponding to FIG. 3 in the printing device 1A of the first embodiment, and FIG. 12 is a view corresponding to FIG. 4 in the printing device 1A of the first embodiment. In FIGS. 11 and 12, constituent members common to the first to third embodiments described above are denoted by the same reference numerals, and detailed descriptions thereof are omitted. Here, the printing device 1D of the present embodiment has the same configuration as the printing device 1 of the first embodiment to the third embodiment except for the configuration of the irradiation device 10. For this reason, the printing device 1D of the present embodiment has the same features as those of the printing device 1 of first embodiment to third embodiment, except for the parts described below.

As shown in FIGS. 11 and 12, the printing device 1D of the present embodiment differs from the printing device 1B of the second embodiment in the following points. Regarding the cover member support section 13, the first bent section 133 is absent, and the distance L2 in the third direction D from the tip end of the first end section 134 to the end section 11E on the side closer to the irradiation section 11 (the right side in FIG. 12) is 5.9 mm. In addition, regarding the light shielding member 14, the distance L5 is 19.4 mm, the distance L6 is 1.8 mm, and the inclination angle θ1 of the light trap member 143 relative to the fourth portion 142 is different.

In the printing device 1D of the present embodiment configured as described above, when the inclination angle θ1 was set to 20°, 50°, and 90°, the measured ultraviolet irradiation leakage values were 0.9×10⁻⁵, 1.1×10⁻⁵, and 1.8×10⁻⁵, respectively. As a result, when the inclination angle θ1 was 50°, the ultraviolet irradiation leakage was suppressed by 39% compared to the case where inclination angle θ1 was 90°. When inclination angle θ1 was 20°, the ultraviolet irradiation leakage was suppressed by 18% compared to the case where inclination angle θ1 was 50°. Therefore, it was found that preferable results can be obtained by setting the inclination angle θ1 to 20° or more and 50° or less.

In the printing device 1D of the present embodiment and the printing device 1B of the second embodiment, it is preferable that the distance L6 between the drum 30 and the second tip end section 143E, which is the drum 30 side tip end of the light trap member 143, is equal to or longer than the distance from the drum 30 to the nozzle surface 21 and equal to or shorter than 1.8 mm. It was found that, with such a configuration, the light trap member 143 can particularly suitably suppress the ultraviolet irradiation leakage with which the ultraviolet curable ink is irradiated.

In the printing device 1D of the present embodiment, the printing device 1B of the second embodiment, and the printing device 1C of the third embodiment, the light trap member 143 is provided in the light shielding member 14. However, the light trap member 143 may be provided in the cover member support section 13.

Here, in the printing device 1D of the present embodiment, the printing device 1B of the second embodiment, and the printing device 1C of the second embodiment, as illustrated in FIGS. 8, 10, and 12, the light trap member 143 includes the third portion 141 extending in the second direction C outside the first portion 131, and the fourth portion 142 extending in the third direction D from an end section of the third portion 141 on the drum 30 side (lower side) in the second direction C. The second end section 144, which is located on the irradiation section 11 side of the fourth portion 142 in the third direction D, includes a second bent section (light trap member 143) that is bent toward the drum 30, and the second tip end section 143E is the end section of the second bent section. With such a configuration, it is possible to easily configure the light trap member 143 capable of suitably suppressing the ultraviolet irradiation leakage irradiated to the ultraviolet curable ink.

In all of the printing device 1D of the present embodiment, the printing device 1B of the second embodiment, and the printing device 1C of the third embodiment, the light shielding member 14 having the light trap member 143 also serves as the wiring protection section 150 that protects the wiring (not illustrated) of the irradiation device 10. With this configuration, the size and structure can be reduced and simplified compared to a configuration in which the light trap member 143 and the wiring protection section 150 are separately provided.

The present disclosure is not limited to the above-described embodiments, and can be realized by various configurations without departing from the scope of the disclosure. For example, the technical features in the embodiments corresponding to the technical features in each aspect described in the outline of present disclosure can be appropriately replaced or combined in order to overcome a part or all of the problems described above or in order to achieve a part or all of the effects described above. If the technical features are not described as essential in this specification, the technical features can be appropriately deleted.

What is claimed is:

1. A printing device comprising:
a head having a nozzle surface in which are formed nozzles configured to eject ultraviolet curable ink;
an irradiation device that irradiates, with ultraviolet rays, the ultraviolet curable ink that was ejected from the nozzles and that landed on a print medium;
a movement section configured to move the print medium and the irradiation device relative to each other in a relative movement direction; and
a medium support section that supports the print medium at a position facing the head and the irradiation device, wherein
the irradiation device includes
an ultraviolet irradiation section configured to irradiate the ultraviolet rays, an irradiation range of the ultraviolet rays extending in a first direction intersecting the relative movement direction,
a cover member that is arranged between the medium support section and the irradiation section and that has translucency, and
a cover member support section that supports one end section and an other end section of the cover member in the relative movement direction and that has a light shielding property,
the cover member support section includes
a first portion extending in a second direction in which the cover member and the medium support section face each other and
a second portion that extends from an end section of the first portion on the medium support section side in a third direction, which intersects the first direction and the second direction,
a first end section of the second portion, which is an end section on the irradiation section side in the third direction, has a first bent section bent toward the medium support section side,
the first bent section is arranged to span from the one end section of the irradiation section to the other end section in the first direction,
a first tip end section, which is a tip end of the first bent section, is arranged within a distance of 0.3 mm from an end section on a side closer to the irradiation section toward the first portion in the third direction, and
a distance of the first tip end section from the medium support section in the second direction is equal to or greater than a distance from the medium support section to the nozzle surface in the second direction and also is equal to or less than 50% of a distance from the medium support section to the cover member in the second direction.

2. The printing device according to claim 1, further comprising:
a light trap member that is arranged below the second portion and that extends in the second direction, wherein
the light trap member is arranged to span from the one end section of the irradiation section to the other end section in the first direction and
an inclination angle with respect to the second portion is 20 degrees or more, and 50 degrees or less.

3. The printing device according to claim 2, wherein
the distance between a second tip end section of the light trap member, which is the tip end on the medium support section side, and the medium support section, is greater than or equal to the distance from the medium support section to the nozzle surface, and less than or equal to 1.8 mm.

4. The printing device according to claim 3, wherein
the light trap member includes
a third portion extending in the second direction to outside the first portion and
a fourth portion extending in the third direction from the end section on the medium support section side of the third portion in the second direction,
a second end section, which is the end section on the irradiation section side in the third direction of the fourth portion, has a second bent section that bends toward the medium support section side, and
the second tip end section is a tip end of the second bent section.

5. The printing device according to claim 2, wherein
the light trap member also serves as a wiring protection section that protects wiring of the irradiation device.
